(19) United States
(12) Patent Application Publication
(10) Pub. No.: US 2015/0134126 A1
(43) Pub. Date: May 14, 2015

(54) INTELLIGENT DRAINAGE SYSTEM

(71) Applicant: INTERNATIONAL BUSINESS MACHINES CORPORATION, Armonk, NY (US)

(72) Inventors: Leonardo R. Augusto, Campinas (BR); Anibal C. Carvalho, Campinas (BR); Tiago N. Santos, Araraquara (BR); Paulo R. Vital, Paulinia (BR); José R. Ziviani, Americana (BR)

(73) Assignee: INTERNATIONAL BUSINESS MACHINES CORPORATION, Armonk, NY (US)

(21) Appl. No.: 14/075,073

(22) Filed: Nov. 8, 2013

(51) Int. Cl. G05D 7/06

(52) U.S. Cl. CPC G05D 7/0617
USPC 700/282

(57) ABSTRACT

A method for diverting water flow of a drainage system is provided. The method comprises receiving monitored information from a plurality of sensors of a drainage system. In one aspect, the drainage system includes at least one valve to control water flow of the drainage system, and wherein the plurality of sensors and the at least one valve are communicatively connected to a controller of the drainage system. Moreover, the method comprises analyzing the monitored information of the plurality of sensors to resolve a maximum flow problem of water flow of the drainage system. The method further comprises identifying a path through the drainage system to divert water flow of the drainage system based on the resolved maximum flow problem. The method further comprises controlling a plurality of valves to divert the water flow in the drainage system based on the identified path of the drainage system.

### FIELD OF THE INVENTION

The present invention relates generally to drainage systems, and more particularly to a system and method for diverting water flow of a drainage system for preventing flooding, or overflow of the water flow, in disaster regions or areas of the drainage system.

### BACKGROUND OF THE INVENTION

Flooding or flood disasters typically occur in known floodplains when prolonged rainfall occurs over several days, intense rainfall occurs over a short period of time, or an ice or debris jam causes a river or stream to overflow and flood the surrounding area. Melting snow can combine with rain in the winter and early spring; severe thunderstorms can bring heavy rain in the spring and summer; or tropical cyclones can bring intense rainfall to coastal or inland regions of certain cities or countries. Further, climate change may also contribute to a rise in extreme weather events including, for example, higher-intensity hurricanes in cities around the world. Flooding can cause a range of health impacts and risks, including: contaminated drinking water, hazardous material spills, increased populations of disease-carrying insects and rodents, moldy houses, and community disruption and displacement. Storm drainage systems are generally utilized to address flood disasters. For example, storm drainage systems are networks of ditches, culverts, pipes, and access structures that work together to direct the flow of flooding.

### SUMMARY

In one embodiment, a method is provided for diverting water flow of a drainage system. The method comprises receiving, by one or more processors, monitored information from a plurality of sensors of a drainage system. The method further comprises analyzing, by the one or more processors, the monitored information of the plurality of sensors to resolve a maximum flow problem of water flow of the drainage system. The method further comprises identifying, by the one or more processors, a path through the drainage system to divert water flow of the drainage system based on the resolved maximum flow problem. The method further comprises controlling, by the one or more processors, a plurality of valves to divert the water flow in the drainage system based on the identified path of the drainage system.

In another embodiment, a computer system is provided for diverting water flow of a drainage system. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to receive monitored information from a plurality of sensors of a drainage system. The computer system further comprises program instructions to analyze the monitored information of the plurality of sensors to resolve a maximum flow problem of water flow of the drainage system. The computer system further comprises program instructions to identify a path through the drainage system to divert water flow of the drainage system based on the resolved maximum flow problem. The computer system further comprises program instructions to control a plurality of valves to divert the water flow in the drainage system based on the identified path of the drainage system.

In yet another embodiment, a computer-program product is provided for diverting water flow of a drainage system. The computer-program product comprises one or more computer-readable tangible storage devices and program instructions stored on at least one of the one or more storage devices. The computer-program product further comprises program instructions to receive monitored information from a plurality of sensors of a drainage system. The computer-program product further comprises program instructions to analyze the monitored information of the plurality of sensors to resolve a maximum flow problem of water flow of the drainage system. The computer-program product further comprises program instructions to identify a path through the drainage system to divert water flow of the drainage system based on the resolved maximum flow problem. The computer-program product further comprises program instructions to control a plurality of valves to divert the water flow in the drainage system based on the identified path of the drainage system.

### BRIEF DESCRIPTION OF THE SEVERAL VIEWS OF THE DRAWINGS

Novel characteristics of the invention are set forth in the appended claims. The invention will be best understood by reference to the following detailed description of the invention when read in conjunction with the accompanying Figures, wherein like reference numerals indicate like components, and:

FIG. 1 is functional diagram of a drainage system environment for diverting water flow of a grid based drainage system for preventing flooding, or overflow of water in disaster regions or areas, in accordance with embodiments of the present invention.

FIG. 2A is an illustration of a water flow through a grid based drainage system, in accordance with embodiments of the present invention.

FIG. 2B is an illustration of a water flow through a grid based drainage system, in accordance with embodiments of the present invention.

FIG. 3 a functional block diagram depicting steps performed by a drainage control system of the drainage system environment of FIG. 1 for preventing flooding, or overflow of water in disaster regions or areas, in accordance with embodiments of the present invention.

FIG. 4 is a functional block diagram of a computer system, in accordance with an embodiment of the present invention.

### DETAILED DESCRIPTION

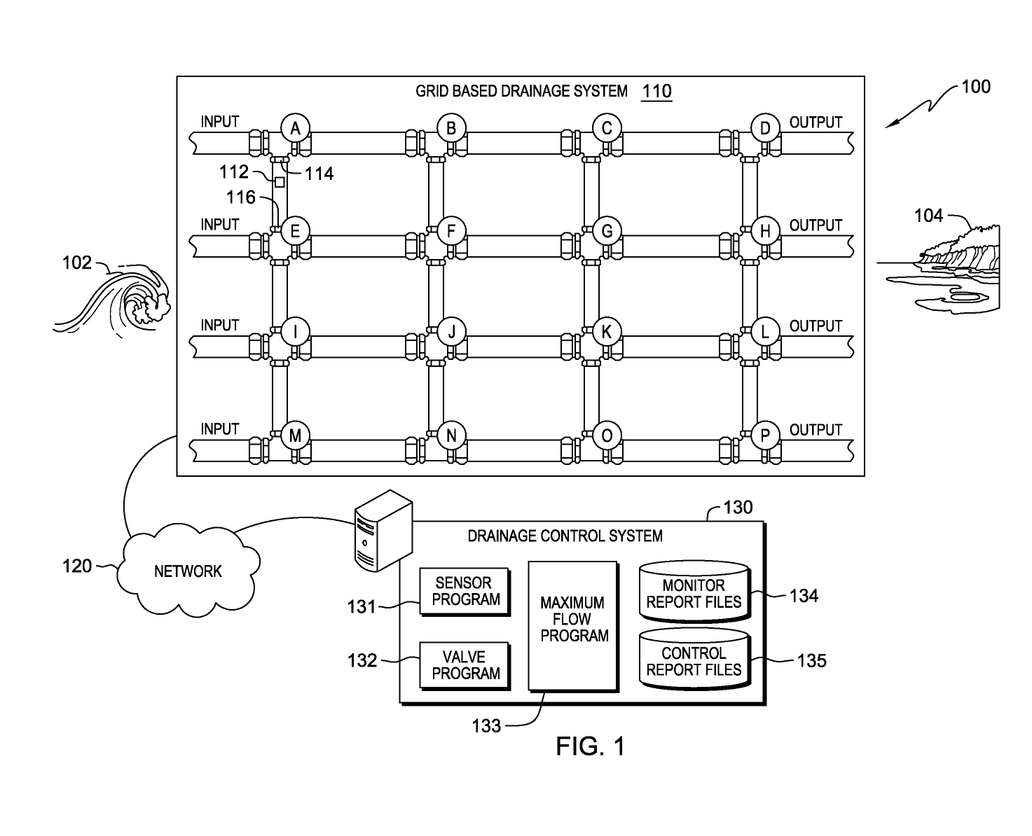

The present invention will now be described in detail with reference to the accompanying Figures. Referring now to FIG. 1, a functional diagram of drainage system environment 100 for diverting water flow of a grid based drainage system for preventing flooding, or overflow of the water flow in disaster regions or areas, in accordance with embodiments of the present invention is shown. As depicted, drainage system environment 100 includes grid based drainage system 110 and drainage control system 130, operatively connected over network 120. Grid based drainage system 110 includes input drainage pipes for receiving flow of water 102 and output drainage pipes for outputting the received flow of water 102 to environment 104, wherein the input and output drainage pipes are connected to one another via a grid-like pattern of pipes and intersections A to P of grid based drainage system 110. As discussed in detail below, drainage control system 130 can solve a maximum flow problem to ensure that all of water 102 that enters the inputs of grid based drainage system 110 exits the outputs into environment 104, which is a satisfactory or safe place for water 102 to be drained to, and to further ensure that none of water 102 that enters the inputs of grid based drainage system 110 floods or overflows out of a pipe or intersection of grid based drainage system 110 prior to reaching environment 104.

The grid-like pattern of grid based drainage system 110 includes intersections A to P through which water 102 is routed in various directions. In one embodiment, intersection points A to P are intersections that unite drainage pipes meeting at right angles to allow water 102 to flow through grid based drainage system 110 in different directions. In other embodiments, intersection points A to P can be intersections that unite drainage pipes meeting at arbitrary angles, or can be intersections that unite fewer than or more than four pipes. Accordingly, it should be understood that although grid based drainage system 110 is depicted as a grid of pipes, this depiction is not limiting, and other embodiments can involve a mesh of pipes intersecting in other geometries, or can involve curved pipes, etc. Grid based drainage system 110 includes a length of pipe connecting intersections A and E (i.e., includes pipe A-E) having valves 114 and 116 that control flow of water 102 passing through pipe A-E. For example, the closure of valve 114 prevents water 102 from flowing between intersection A and pipe A-E, and the closure of valve 116 prevents water 102 from flowing between intersection E and pipe A-E. In various embodiments, valves 114 and 116 may use mechanical techniques or other techniques to control the flow of water 102. Grid based drainage system 110 also includes sensor 112 to monitor flow of water 102 in pipe A-E. It should be understood that one pipe, several pipes, or every pipe in grid based drainage system 110 can include respective sensors and valves corresponding to sensor 112 and valves 114 and 116. For example, pipes A-B, B-C, and C-D can each include a corresponding sensor and a corresponding pair of valves. Valves 114 and 116 may be placed directly at intersection points A and E or on lengths of pipe A-E in between. In another embodiment, a given length of pipe, such as pipe A-E, may have only one valve, no valves, or three or more valves, rather than two valves. Similarly, sensor 112 may be placed anywhere on pipe A-E in between intersection points A and E. In yet another embodiment, sensors are located at intersections, rather than on pipes.

Sensor 112 is a water flow sensing element of grid based drainage system 110. Sensor 112 monitors the flow of water 102 of grid based drainage system 110, periodically, randomly, and/or using event-based monitoring. In one embodiment, sensor 112 transmits an output signal of volume of flow of water 102 of pipe A-E, when the water flow of grid based drainage system 110 approaches the capacity of pipe A-E (e.g., comes within a threshold of the capacity, etc.).

Drainage control system 130 analyzes the monitored information of the sensors, including sensor 112, of grid based drainage system 110 to resolve a maximum flow problem of grid based drainage system 110. According to at least one embodiment, drainage control system 130 compiles statistics of inputs of monitored water flow distribution of water 102 of grid based drainage system 110, analyzes the statistical inputs of the monitored flow of distribution of water 102 of grid based drainage system 110 based on the maximum flow analysis, and transmits a signal to at least one of the valves (e.g., such as valves 114 and 116, etc.), wherein the valves control the flow of water 102 in portions of grid based drainage system 110, based on an identified path to direct or divert the flow of water 102, as described below.

Network 120 includes one or more networks of any kind that can provide communication links between various devices and computers connected together. Network 120 can also include connections, such as wired communication links, wireless communication links, or fiber optic cables. Network 120 can also be implemented as a number of different types of networks, including, for example, a local area network (LAN), a wide area network (WAN) or a packet switched telephone network (PSTN), or some other networked system. For example, drainage system environment 100 can utilize the Internet with network 120 representing a worldwide collection of networks. The term “Internet” as used according to embodiments of the present invention refers to a network or networks that uses certain protocols, such as the TCP/IP protocol, and possibly other protocols such as the hypertext transfer protocol (HTTP) for hypertext markup language (HTML) documents that make up the World Wide Web (the Web).

Drainage control system 130 is a server computing system such as a management server, a web server, or any other electronic device or computing system capable of receiving and sending data. Drainage control system 130 can also represent a “cloud” of computers interconnected by one or more network, wherein drainage control system 130 is a primary server for a computing system utilizing clustered computers.

Drainage control system 130 can also be a laptop, a tablet, or a notebook personal computer (PC), a desktop computer, a mainframe or mini computer, a personal digital assistant (PDA), or a smart phone. Drainage control system 130 includes sensor program 131, valve program 132, maximum flow program 133, monitoring report files 134, and control report files 135. Monitoring report files 134 stores monitored information of water flow of grid based drainage system 110, wherein the monitored information is transmitted by sensors, including sensor 112, based on monitored water flow of water 102 of grid based drainage system 110.

The monitored information of water 102 of grid based drainage system 110 can be stored in monitoring report files 134 for future retrieval by sensor program 131. Control report files 135 stores information pertaining to control of water flow by valves, including valves 114 and 116. Further, valve program 132 communicates with valves, such as valves 114 and 116, to control the water flow in respective portions of grid based drainage system 110 based on information of control report files 135, or based on input from maximum flow program 133. Maximum flow program 133 can analyze the monitored information of sensor program 131 to resolve a maximum flow problem of the water flow of grid based drainage system 110.

The resolution of the maximum flow problem by maximum flow program 133 can involve finding a feasible flow through a flow network, representative of grid based drainage system 110 that is maximum. In particular, maximum flow program 133 can load or generate a flow network graph data structure representative of grid based drainage system 110, and can find a feasible flow through the flow network graph data structure by performing a linear programming maximum flow algorithm, a Ford-Fulkerson algorithm, an Edmonds-Karp algorithm, a Dinitz blocking flow algorithm, a general push-relabel maximum flow algorithm, a push-relabel algorithm with FIFO vertex selection rule, a Dinitz blocking flow algorithm with dynamic trees, a push-relabel algorithm with dynamic trees, a binary blocking flow algorithm, a Malhotra, Pramodh-Kumar and Maheshwari algorithm, a Jim Orlin + King, Rao, Tarjan algorithm, or the like.

The resolution of the maximum flow problem can be further based on a determination of whether a sum of water flow that enters an intersection point of at least one of intersection points A to P of grid based drainage system 110 is equal to the sum of water that exits the intersection point of the at least one intersection points A to P. For example, according to at least one embodiment, a maximum flow problem algorithm of the present invention can determine a path through intersections points A to P, from which, for example, a source (start node) of intersection points A to P, to a sink of intersection points A to P (end node) with available capacity on all edges of the path, wherein water flow is transmitted along one of the paths of intersection points A to P. According to at least one embodiment, maximum flow program 133 compares actual flow level of water of grid based drainage system 110 with normal or regular water flow capacity of each of the at least one intersection points A to P of grid based drainage system 100, based on the maximum flow of the at least one intersection points A to P. Maximum flow program 133 also utilizes information of the compared flow of water of each intersection of the at least one intersection points A to P of grid based drainage system 110 to determine the water flow parameters of a best path for water flow distribution of grid based drainage system 110, for preventing flood or overflow of water in disaster regions or areas, in accordance with embodiments of the present invention. Maximum flow program 133 transmits the determined water flow parameters of the best path to valve program 132 which transmits a signal to valves, such as valves 114 and 116, to control the water flow in portions of the at least one intersection points A to P based on the identified path through grid based drainage system 100.

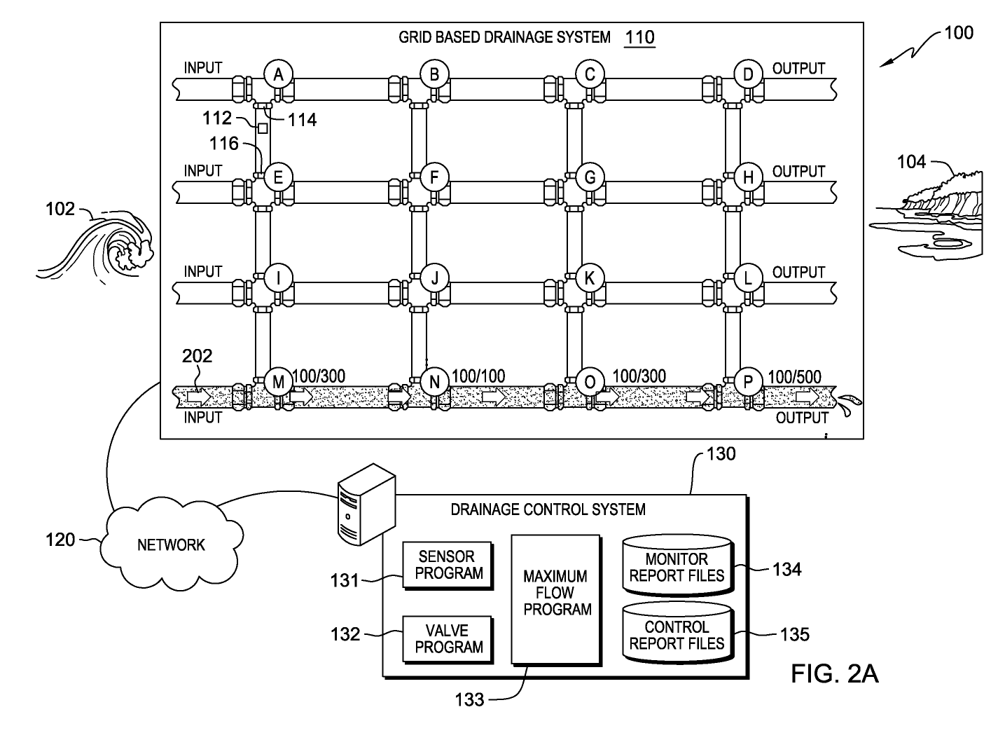

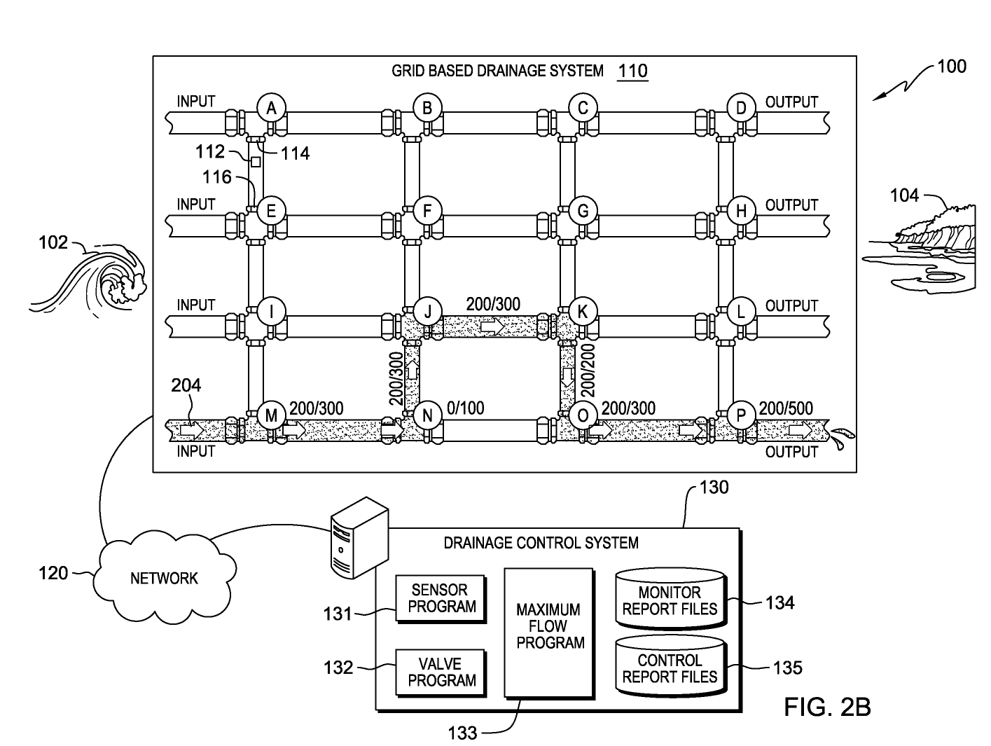

FIG. 2A is an illustration of water flow 202 through grid based drainage system 110. Water flow 202 flows through intersection points M, N, O, and P based on an uncontrolled path of water flow. The path is uncontrolled because, for example, maximum flow program 133 has not yet solved a maximum flow problem to determine a best path. In the depicted illustration, for example, water flow capacities are 300 liters per second through pipe M-N, 100 liters per second through pipe N-O, 300 liters per second through pipe O-P, and 500 liters per second between intersection point P to an output of grid based drainage system 110. As illustrated, pipe N-O is operating at its maximum flow capacity of 100 liters per second, while the rest of the pipes are operating under their maximum flow capacities (e.g., pipe M-N is operating at one third of its maximum flow capacity, etc.). Any additional water volume at pipe N-O would cause stoppage of water flow at intersection point N, thus causing a flood or other overflow at intersection point N, or a backup leading to a flood or other overflow at intersection point M, etc. According to one embodiment, for example, the additional water volume at pipe N-O is monitored by one or more sensors, such as a sensor of pipe N-O, a sensor of pipe M-N, or both, etc. Sensor program 131 compiles statistics of inputs of the monitored water flow, and maximum flow program 133 analyzes the statistical inputs of the monitored water flow distribution based on maximum flow problem analysis, and transmits a signal through valve program 132 to valves affecting water flow 202 to control water flow 202 of grid based drainage system 110, by tracing a new route to divert water flow 202 to a best path as illustrated in FIG. 2B.

FIG. 2B is an illustration of water flow 204 through grid based drainage system 110. Water flow 204 flows through intersection points M, N, J, K, O, and P based on a determination by maximum flow program 133 of a best path to divert water flow away from pipe N-O of grid based drainage system 110. As illustrated, pipe N-O is closed due to the determination of a best path to control water flow of grid based drainage system 110. Moreover, maximum flow program 133 traced a new path within grid based drainage system 110 to reduce water flow of affected section of overflow of water flow of pipe N-O of grid based drainage system 110. According to at least one embodiment, valves control water flow of grid based drainage system 110 based on the monitored flow of water by sensors. Notably, although the illustration of water flow 204 involves a closure of pipe N-O to divert water flow 202 away from pipe N-O, in another embodiment the resolution of the maximum flow problem by maximum flow program 133 can involve finding a combination of water flow 202 and water flow 204, i.e., a water flow that flows through all of pipes M-N, N-J, J-K, K-O, N-O, and O-P.

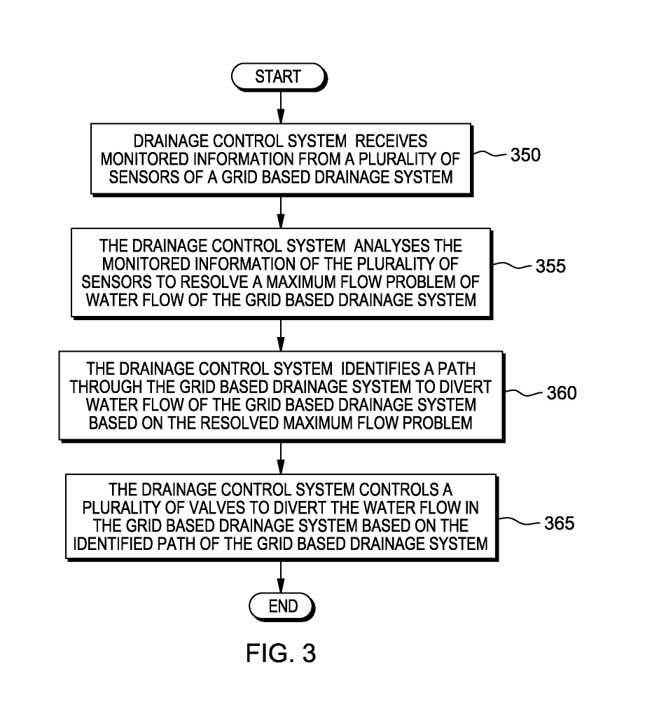

FIG. 3 is a functional block diagram depicting steps performed by drainage control system 130 of drainage system environment 100 of FIG. 1 for preventing flooding, or overflow of water in disaster regions or areas, in accordance with embodiments of the present invention.

Sensor program 131 of drainage control system 130 receives monitored information from sensors, such as sensor 112, of grid based drainage system 110 (Step 350). Maximum flow program 133 of drainage control system 130 analyzes the monitored information to resolve a maximum flow problem of water flow of grid based drainage system 110 (Step 355), and identifies a path through grid based drainage system 110 to divert water flow of grid based drainage system 110 based on the resolved maximum flow problem (Step 360).

For example, as described above, maximum flow program 133 can compare actual flow level of water of grid based drainage system 110 with normal water flow capacity of each of the pipes of grid based drainage system 110. Maximum flow program 133 also utilizes information of the compared flow of water of each intersection of the at least one intersection points A to P of grid based drainage system 110 to determine the most suitable water flow distribution of grid based drainage system 110, for preventing flooding or overflow of water in disaster regions or areas, in accordance with embodiments of the present invention. Valve program 132 of drainage control system 130 controls the water flow in grid based drainage system 110 based on the identified path of grid based drainage system 110 (Step 365). For example, as described, grid based drainage system 110 includes valves, such as valves 114 and 116, that are placed around at least one of intersection points A to P to control the flow of water 102, wherein the valves control the flow of water based on an identified path to divert the flow of water 102 through grid based drainage system 110.

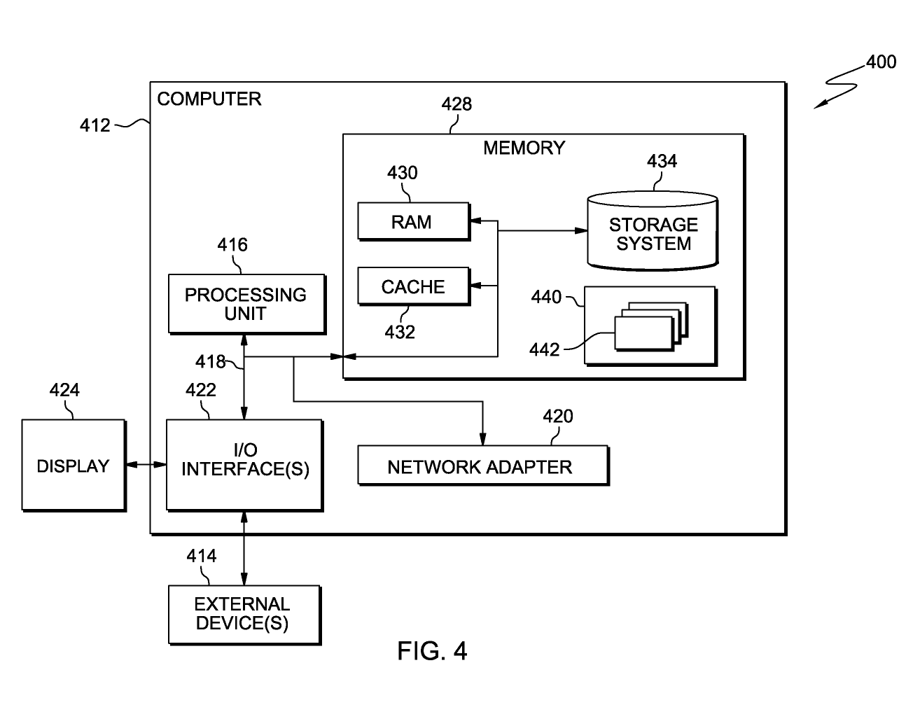

FIG. 4 is a functional block diagram of a computer system 400, in accordance with an embodiment of the present invention. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove. In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Drainage control system 130 can include or can be implemented as an instance of computer 412.

Computer 412 may be described in the general context of computer system executable instructions, such as program modules being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 is shown in the form of a general-purpose computing device. The components of computer 412 may include, but are not limited to, one or more processors or processing unit 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

In an exemplary embodiment of the present invention, an operating system may be stored in memory 428 by way of example, and not limitation, as well as one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Sensor program 131, valve program 132, and maximum flow program 133 can be implemented as or can be an instance of program 440.

Computer 412 may also communicate with one or more external device(s) 414 such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication can occur via Input/Output (I/O) interface(s) 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer-program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system, method or computer-program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer-program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer-program product for diverting water flow of a grid based drainage system, for preventing flooding, or overflow of the water flow in disaster regions or areas have been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A computer-implemented method for diverting water flow of a drainage system, the computer-implemented method comprising the steps of:
receiving, by one or more processors, monitored information from a plurality of sensors of a drainage system;
analyzing, by the one or more processors, the monitored information of the plurality of sensors to resolve a maximum flow problem of water flow of the drainage system;
identifying, by the one or more processors, a path through the drainage system to divert water flow of the drainage system based on the resolved maximum flow problem; and
controlling, by the one or more processors, a plurality of valves to divert the water flow in the drainage system based on the identified path of the drainage system.

2. The computer-implemented method of claim 1, wherein the sum of water that enters an intersection point of the drainage system is equal to the sum of water flow that exits the intersection point.

3. The computer-implemented method of claim 1, wherein an intersection point of the drainage system includes at least two pipes that are connected at substantially right angles.

4. The computer-implemented method of claim 1, wherein the plurality of sensors and the plurality of valves are communicatively connected to a controller of the drainage system.

5. The computer-implemented method of claim 4, wherein the plurality of valves diverts water flow of the drainage system based on water flow control parameters transmitted by the controller of the drainage system.

6. The computer-implemented method of claim 4, wherein the controller traces a path to divert water flow of the drainage system.

7. The computer-implemented method of claim 1, wherein the step of identifying, by the one or more processors, a path through the drainage system to divert water flow of the drainage system based on the resolved maximum flow problem, further includes the step of:
diverting, by the one or more processors, at least one route of a path for water flow of the drainage system, if it is determined that another path for water flow of the drainage system cannot receive a volume of water flow of the drainage system.

8. A computer system for diverting water flow of a drainage system, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to receive monitored information from a plurality of sensors of a drainage system;
program instructions to analyze the monitored information of the plurality of sensors to resolve a maximum flow problem of water flow of the drainage system;
program instructions to identify a path through the drainage system to divert water flow of the drainage system based on the resolved maximum flow problem; and
program instructions to control a plurality of valves to divert the water flow in the drainage system based on the identified path of the drainage system.

9. The computer system of claim 8, wherein the sum of water that enters an intersection point of the drainage system is equal to the sum of water flow that exits the intersection point.

10. The computer system of claim 8, wherein an intersection point of the drainage system includes at least two pipes that are connected at substantially right angles.

11. The computer system of claim 8, wherein the plurality of sensors and the plurality of valves are communicatively connected to a controller of the drainage system.

12. The computer system of claim 11, wherein the plurality of valves diverts water flow of the drainage system based on water flow control parameters transmitted by the controller of the drainage system.

13. The computer system of claim 11, wherein the controller traces a path to divert water flow of the drainage system.

14. The computer system of claim 8, wherein program instructions to identify a path through the drainage system to divert water flow of the drainage system based on the resolved maximum flow problem, further includes:
program instructions to divert at least one route of a path for water flow of the drainage system, if it is determined that another path for water flow of the drainage system cannot receive a volume of water flow of the drainage system.

15. A computer-program product for diverting water flow of a drainage system, the computer-program product comprising:
one or more computer-readable tangible storage devices, and program instructions which are stored on at least one of the one or more storage devices, the program instructions comprising:
program instructions to receive monitored information from a plurality of sensors of a drainage system;
program instructions to analyze the monitored information of the plurality of sensors to resolve a maximum flow problem of water flow of the drainage system;
program instructions to identify a path through the drainage system to divert water flow of the drainage system based on the resolved maximum flow problem; and
program instructions to control a plurality of valves to divert the water flow in the drainage system based on the identified path of the drainage system.

16. The computer-program product of claim 15, wherein the sum of water that enters an intersection point of the drainage system is equal to the sum of water flow that exits the intersection point.

17. The computer-program product of claim 15, wherein an intersection point of the drainage system includes at least two pipes that are connected at substantially right angles.

18. The computer-program product of claim 15, wherein the plurality of sensors and the plurality of valves are communicatively connected to a controller of the drainage system.

19. The computer-program product of claim 18, wherein the plurality of valves diverts water flow of the drainage system based on water flow control parameters transmitted by the controller of the drainage system.

20. The computer-program product of claim 15, wherein program instructions to identify a path through the drainage system to divert water flow of the drainage system based on the resolved maximum flow problem, further includes:
program instructions to divert at least one route of a path for water flow of the drainage system, if it is determined that another path for water flow of the drainage system cannot receive a volume of water flow of the drainage system.
